(19) United States
(12) Patent Application Publication
(10) Pub. No.: US 2009/0049674 A1
(43) Pub. Date: Feb. 26, 2009

(54) HOLLOW BAR MANUFACTURING PROCESS

(76) Inventor: Tom Eric Wilson, Mayfield (AU)

Correspondence Address: LADAS & PARRY LLP, 224 SOUTH MICHIGAN AVENUE, SUITE 1600, CHICAGO, IL, 60604, US

(21) Appl. No.: 12/092,302

(22) PCT Filed: Nov. 1, 2006
(86) PCT No.: PCT/AU06/01633

§ 371 Date: Aug. 27, 2008

(30) Foreign Application Priority Data
Nov. 4, 2005 (AU) 2005906130

(51) Int. Cl. B23P 11/00; B21B 41/02

(52) U.S. Cl. 29/505; 72/231

(57) ABSTRACT

A process for forming a relatively thick-walled hollow bar by hot rolling an elongate member including the steps:

(i) in at least one pass, rolling the elongate member so as to generally define at least two longitudinally extending portions of the hollow bar;

(ii) in at least one pass, bending the resultant rolled member from (i) so as to bring outer edges of the elongate member into proximity with each other.

After step (i) the resultant portions are interconnected at a longitudinal region of bar material that is formed so as not to act as a hinge during bending step (ii).

### TECHNICAL FIELD

An improved process for manufacturing hollow bars is disclosed. The process finds particular though not exclusive application in the production of a thick-walled hollow bar for use as feedstock for a rock bolt or drill rod.

### BACKGROUND ART

WO 2005/021182 discloses a process that forms a substantially thick-walled hollow bar by hot rolling an elongate steel billet. The billet is roll formed to define two longitudinally extending elongate half members interconnected by a longitudinally extending and substantially thinner hinge. The outer edges of the half members are then brought into contact with each other by bending the members around the hinge. At the priority date of WO 2005/021182 it was thought that a hinge was necessary for the subsequent bending operation.

Where a hinge is formed in the process, a potential area of weakness may result in the final formed bar. This weakness may be exposed when the bar is used in applications where it is subjected to high torsional loads (eg. as a rock bolt or drill rod). Also, where fluid at high pressure is pumped through a bore of the hollow bar, weakness in the wall at the hinge may cause the bar at some point to inadvertently rupture.

### SUMMARY

In a first aspect there is provided a process for forming a relatively thick-walled hollow bar by hot rolling an elongate member, the process comprising the steps:

(i) in at least one pass, rolling the elongate member so as to generally define at least two longitudinally extending portions of the hollow bar;

(ii) in at least one pass, bending the resultant rolled member from (i) so as to bring outer edges of the elongate member into proximity with each other;

wherein after step (i) the resultant portions are interconnected by a longitudinal region of bar material that is formed so as not to act as a hinge during bending step (ii).

In a second aspect there is provided a process for forming a relatively thick-walled hollow bar by hot rolling an elongate member, wherein the rolling takes place in a manner whereby no hinge is produced during formation of the hollow bar.

These first and second aspects are to be contrasted with WO 2005/021182. In the present method the wall thickness is maintained during bending to be essentially uniform and there is no clearly defined (or distinct) hinge. Rather, in the present method bending occurs at multiple points around the bar as it forms. Thus, the rolling and bending can be performed without the formation of or requirement for a hinge. For example, no defined hinge is roll formed in the process that extends between longitudinally extending portions of an elongate member (as occurs with WO 2005/021182). The expressions “not to act as a hinge” and “no hinge is produced” should thus be interpreted in this regard.

Also, as no hinge is present, the resultant hollow bar produced in this process does not produce a region of weakness in the final rolled bar that can otherwise be located at such a hinge. This can render the hollow bar more suitable for applications in which the bar is subjected to high torsional loads, such as when subsequently employed as a rock bolt or drill rod.

Further, the formation of a hinge may subsequently result in an externally protruding longitudinal ridge of material in the final rolled bar. The absence of a hinge during the rolling formation of the hollow bar can thus mitigate the formation of a longitudinal ridge of material.

The terminology “relatively thick-walled” when used in relation to the hollow bar is employed to refer to a ratio of bar diameter to wall thickness as compared with known rolled pipe and tube. For example, in cold-rolled steel pipe a high ratio of pipe diameter to wall thickness results in a relatively thin-walled pipe.

In the pipe and tube industries this ratio is known as the D/t ratio (i.e. the ratio between tube diameter and wall thickness). Pipe/tube sections with a description “heavy wall” would generally have a D/t ratio <˜12. Sections with a D/t ratio of 9 would thus be described as “heavy wall”, requiring a special type of mill for manufacture. A section with a D/t ratio of 5 would be described as “very heavy wall”. The present process is able to produce hollow bar with a D/t of around 3.

Also, the use of the terminology “hollow bar” is not intended to exclude the process from producing relatively thick-walled pipe and tube, such that the term “hollow bar” is to be construed to include pipe and tube.

The longitudinal region of bar material can be formed to have substantially the same thickness as the portions. It should be understood that the terminology “substantially the same thickness” includes the case where the longitudinal region has the same thickness as the portions.

In step (ii) the elongate member outer edges can be brought together to closely abut. In addition, in step (i) ends of the elongate member outer edges can each have a mating surface formed thereon to assist with a close facing abutment. This close facing abutment enables a joint to subsequently be formed such that the resultant hollow bar can later be employed in applications in which it can receive fluid under pressure therethrough with less likelihood of fluid leakage.

For example, in end profile, each mating surface can comprise a curved portion and a bevelled portion. Then, when the outer edges are brought together into close facing abutment, the curved portions can initially engage and roll over each other until the bevelled portions come into direct facing engagement. This arrangement can further promote the close facing abutment, and can prevent inward collapsing of the outer edges during this action.

The process may further comprise a final roll pass after the bending step (ii) in which the final profile of the hollow bar is formed. In addition, in the final roll pass, a plurality of ribs can be formed at the external surface of the hollow bar.

In one variation the plurality of ribs can be formed so as to define a thread-type formation on the external surface of the hollow bar (eg. for the external mounting of bits etc on the bar and/or for the bar's screw-mounting into apparatus, such as drilling apparatus).

In other variations the plurality of ribs can be formed as a series of transverse ribs that can be formed straight (ie. not as a thread), as a random shape that is repeated (eg. at intervals that relate to the forming roll circumference), or as an impressed form. Other variations of ribbing are also possible.

In use the ribs can also function to assist with load transfer of the bar in rock strata, and can increase the resistance of the bar to being pulled out from material in which the bar is embedded (eg. grout).

In the process step (i) the elongate member can be rolled in a first pass to define two longitudinally extending portions, each having a U-shape in end profile. The longitudinal region of bar material can then interconnect the two longitudinally extending U-shaped portions.

In the process step (i) the member resulting from the first pass can be rolled in a second pass to further define the U-shaped profile of each of the two longitudinally extending portions. At the same time the second pass can define an inverted U-shaped profile in the longitudinal region of bar material that interconnects the two longitudinally extending portions. This can impart a rounded W-shaped profile to the member.

Thus, the first and second roll passes can optimise the member profile for the subsequent bending operation.

In the process step (ii) the member resulting from the second pass can be subjected to a five pass bending operation in which opposing edge regions of the member are progressively brought together to bring the end surfaces of the outer edges of the member into close abutment. For example, the step (ii) bending operation can take place in a hot rolling mill unit comprising five adjacent roll pairs, with each roll pair performing a next successive pass in the bending operation. Such bending is able to take place without the formation of a hinge in the member. It is also possible to operate step (ii) with either less or more than five bending passes, depending on the bar to be produced.

The hot rolling mill unit can be operated at a speed which is consistent with the speed of operation of the roll forming step (i), so that process throughput and economics are maintained.

A usual though not exclusive material for the elongate member is steel and the process can thus form part of a hot rolling process in a steel mill.

A usual though not exclusive starting material for the elongate member is barstock. This barstock can originate from a prior rolling process, or it can be directly supplied as pre-heated barstock. If the barstock originates from a prior rolling process, the present process (ie. of the first and second aspects) can be operated such that this hot-rolled barstock is then fed directly from that prior process and into the present process in a continuous operation. Further, the barstock can originally be produced from a billet.

Thus, it can be seen that the present process can take barstock and form and bend it in a way that produces an end product that is quite different to the original feed material. This is to be contrasted with known processes for forming rolled pipe and tube, which essentially preserve the profile of feed material.

The hollow bar produced by the process can be suitable as a feedstock for a rock bolt or a drill rod, and thus the process provides a fast, low-cost means of producing such products.

In a third aspect there is provided apparatus for bending a hot rolled elongate member so as to form a hollow bar, the apparatus comprising a plurality of adjacent roll pairs which are oriented so as to cause outer edges of the elongate member to progressively be brought into proximity with each other, whereby a hollow bar is formed.

Such an apparatus can be used to replace what would otherwise be a series of bending passes in a standard mill. Thus, it can simplify both the manufacture and formation of a hollow bar, and can improve process economics.

The apparatus may in one form comprise two or more (typically three) adjacent horizontal roll pairs into which the elongate member is progressively fed to progressively bend distal edges of the elongate member towards each other. It may then comprise a next adjacent vertical roll pair to bend the distal edges such that the outer edges are caused to abut and form a hollow bar. It may further comprise a final horizontal roll pair into which the hollow bar from the vertical roll pair is fed to bring the outer edges together and into a very close facing abutment. In this respect, the apparatus can be suitable for use in the process of the first and second aspects.

### BRIEF DESCRIPTION OF THE DRAWINGS

Notwithstanding any other forms which may fall within the scope of the process and apparatus as defined in the Summary, specific embodiments of the process and apparatus will now be described, by way of example only, with reference to the accompanying drawings in which:

FIG. 1 schematically depicts, in end cross-sectional elevation, the sequence steps (a) to (i) for the process of hot rolling a hollow bar;

FIGS. 1A to 1C illustrate three different feed bar profiles, with FIG. 1A illustrating a similar profile to that shown in FIG. 1(a), with FIG. 1B illustrating a simple variation to FIG. 1A, and with FIG. 1C illustrating a more complex variation to FIG. 1A;

FIGS. 2(a) to 2(c) respectively show end, plan and side elevations of a section of hot rolled hollow bar resulting from the process depicted in FIG. 1 and illustrating one embodiment of a thread formation thereon, with FIG. 2(d) showing a cross-sectional detail through a thread; and

FIGS. 3(a) to 3(e) respectively show plan, side, front perspective, end and reverse perspective views of a compact hot rolling mill configuration in which the bending passes to produce the hollow bar of FIG. 2 take place.

### DETAILED DESCRIPTION OF SPECIFIC EMBODIMENTS

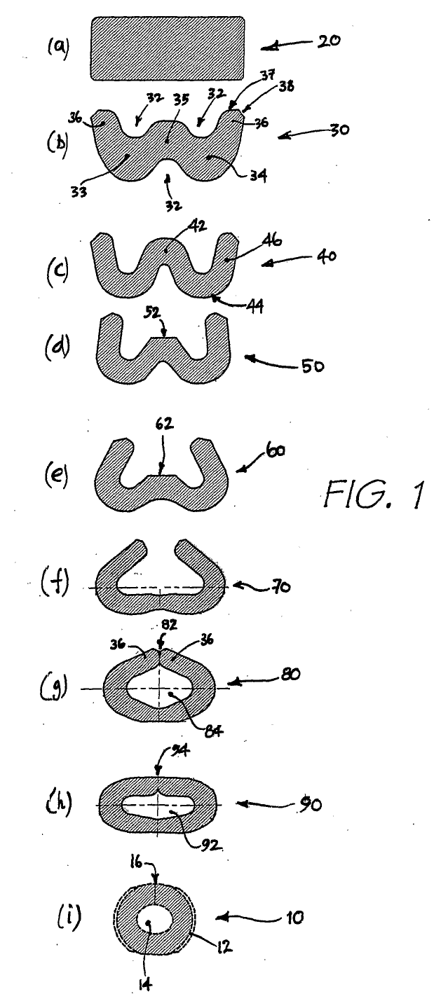

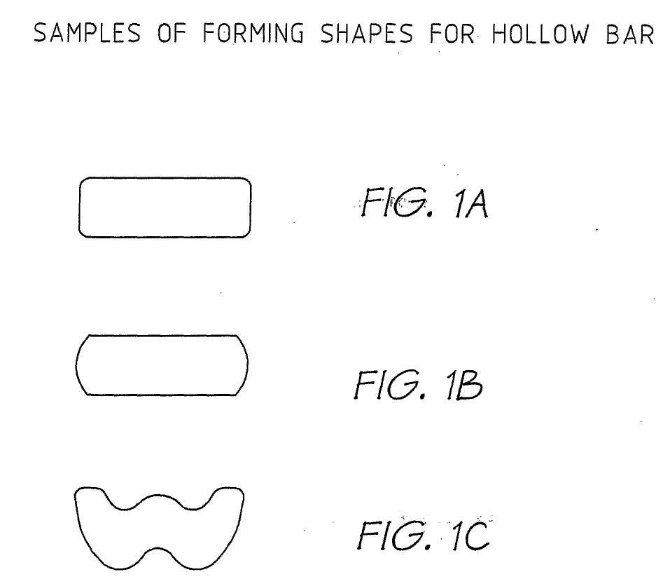

FIGS. 1(a) to 1(i) depict the progressive formation of a hollow bar 10 comprising ribs 12 (which in this embodiment define a type of thread), a bore 14 therethrough, and a region 16 of close-facing abutment. External ribs are formed on the bar where, for example, the bar is to be used as feedstock for a rock bolt or drill rod. The resultant thread allows for a cutting tip etc to be externally mounted on the end of the bolt/rod, and for the bolt/rod to be coupled into a drilling apparatus etc.

The ribs 12 can alternatively be formed as a series of transverse ribs that can be formed straight (ie. not as a thread). In another embodiment the ribs can have a random shape that is repeated (eg. at irregular or regular intervals that relate to the forming roll circumference). In a further embodiment they can be replaced by impressions formed into the bar. In yet another embodiment they can be misaligned. The ribs may also be formed to define a type of helical thread.

In any case, the ribs (or impressions) are typically formed on the bar in a final roll pass through a rolling mill, at the same time as the final cross-sectional profile of the bar is defined. If formed earlier in the process the ribs may be damaged by one or more of the roll passes which would then follow rib formation. In practice it would be extremely difficult to roll form ribs in an early pass and then expect to undertake rolling in subsequent passes without erasing or severely damaging the ribs.

The process sequence of FIG. 1 will now be described.

FIG. 1(a) shows a section through a feed bar 20 of steel that is typically supplied from a previously hot rolled billet. The bar may be formed from a billet in immediately prior rolling passes (to provide for a continuous process), or can be a prior rolled billet that is then reheated in a furnace of a steel mill prior to hot rolling. Typically the bar is heated to a temperature somewhere in the range 600-1200° C., more typically around 900-1200° C.

Whilst the feed bar shape shown in FIG. 1(a) is a typical indication it should be appreciated that the bar could be rolled so as to provide many other starting shapes. For example FIG. 1A illustrates a slight variation in profile to that shown in FIG. 1(a). FIG. 1B illustrates another simple variation to FIG. 1(a), whereby the side walls bow out slightly. FIG. 1C illustrates a more complex W-profile which, if used as the starting profile, reduces the amount (extent) of work required in the subsequent mill.

Referring now to FIG. 1(b), a section 30 is shown after the bar 20 has passed through a first forming pass, in which “cuts” 32 are formed into the top and bottom of the bar. This first forming pass generally defines at least two longitudinally extending portions 33 and 34 that are interconnected by a longitudinal region 35. The portions 33, 34 each have a U-shaped profile. The rolling process is conducted so that the region 35 does not act as a hinge during the subsequent bending steps described below.

In FIG. 1(b) it will also be seen that free ends 36 (or “toes”) of each portion 33, 34 each have a mating face formed thereon to assist in obtaining a close-facing abutment. In one embodiment, and when viewed in end profile, each mating face may comprise a curved portion 37 and a bevelled portion 38. However, the curved portion and the bevelled portion need not be that profile. For example, the ends 36 can have a round or irregular profile, and may be overfilled or underfilled in the resulting bar. In this regard, metal may flow into any gap between the roll and the abutting ends 36. This would then be a situation of overfill, on one side or on both sides of the abutment. Alternatively, there may not necessarily be a fill or be full contact between the curved portions. In this case the abutting ends will be underfilled. Further, these situations do not prevent the mill or this process from rolling and producing a hollow bar.

The bevel portion 38 may actually be defined as a condition of the mill to allow for material variation whilst rolling. Further, the bevelled portion 38 is an indication of the bar fill in the pass. The shape of the fill does not per se effect the obtaining of a close-facing abutment. Whilst it is depicted as a bevel, it could be defined by a radii or an irregular surface. A bevel surface provides clearance and results in less metal needing to be forced into roll gaps (see FIGS. 1(g) and (h)) in a final (finishing) pass.

As described below, when the free ends 36 are subsequently brought together into close-facing abutment it is surmised that the curved portions 37 may initially engage and roll over each other until the bevelled portions 38 come into direct facing engagement, thus enabling further close abutment and preventing inward collapse of the free ends 36.

FIG. 1(c) shows a section 40 after the section 30 has passed through a second forming pass, in which the wall thickness of the finished hollow bar is defined, together with the size of the bore through the subsequently produced hollow bar. The second forming pass further defines the U-shape of the portions 33, 34 and now defines the region 35 as an inverted U-shape 42 that interconnects U-shaped portions 33, 34. FIG. 1(c) shows that the section 40 now has a distinct W-shape in profile. The second forming pass also further defines the curved portion 37 and the bevelled portion 38 such that they are now ready to be brought together into close-facing abutment.

Rolling the profile with the free ends 36 located uppermost as shown helps to minimise the cooling of these ends throughout the rolling process. This profile orientation also maintains the region 42 up out of any cooling water in the mill, thus preventing this region from cooling too quickly (which may otherwise hinder subsequent bending operations). However, it is still possible to roll the profile with the free ends 36 located lowermost, without this impacting too significantly on the various bending operations.

In FIG. 1(c), the length of each U-shaped portion 33, 34 is also such that the bevelled edges 38 of ends 36 will be brought into proximity with each other at a top centre of the subsequently formed hollow bar. Further, in section 40 the wall thickness at the bottom of each of a lobe 44 of the portions 33, 34 is maintained slightly thicker than the sides 46, to provide material for subsequent rib formation. However, the provision of lobes may not be necessary, as a large amount of roll work in the final pass can still cause the ribs to form. Also, extra material in the lobes, if not removed by section elongation, may fill the pass and reduce the size of the resultant bore in the bar.

FIG. 1(d) shows a section 50 after the section 40 has been subjected to a first bending pass, which is performed so as to initiate the bending process, including an inward bending of the sides 46. In this first bending pass some minor form work also occurs to define land 52 located about a vertical centreline through the section. It should be noted that there is no formation of any distinct hinge point or region during this or the subsequent bending stages, with bending having taken place throughout the section 50. Because the bending is performed without the requirement for a hinge, the resultant hollow bar 10 does not then comprise a region of weakness defined in the final rolled bar adjacent to and attributable to such a hinge. Also, any externally protruding longitudinal ridge of material that may otherwise form as a result of such a hinge can be avoided.

FIG. 1(e) shows a section 60 after the section 50 has been subjected to a second bending pass, which is performed so as to continue the bending process. Again, in this second bending pass some minor form work also occurs to further define (flatten) the land at 62, located about the vertical centreline through the section.

FIG. 1(f) shows a section 70 after the section 60 has been subjected to a third bending pass, which is performed so as to continue the bending process around an imaginary central axis of the section. The bending is also conducted to avoid inward collapse of the ends of the section, as well as to prevent a middle of the section centre from collapsing inwards.

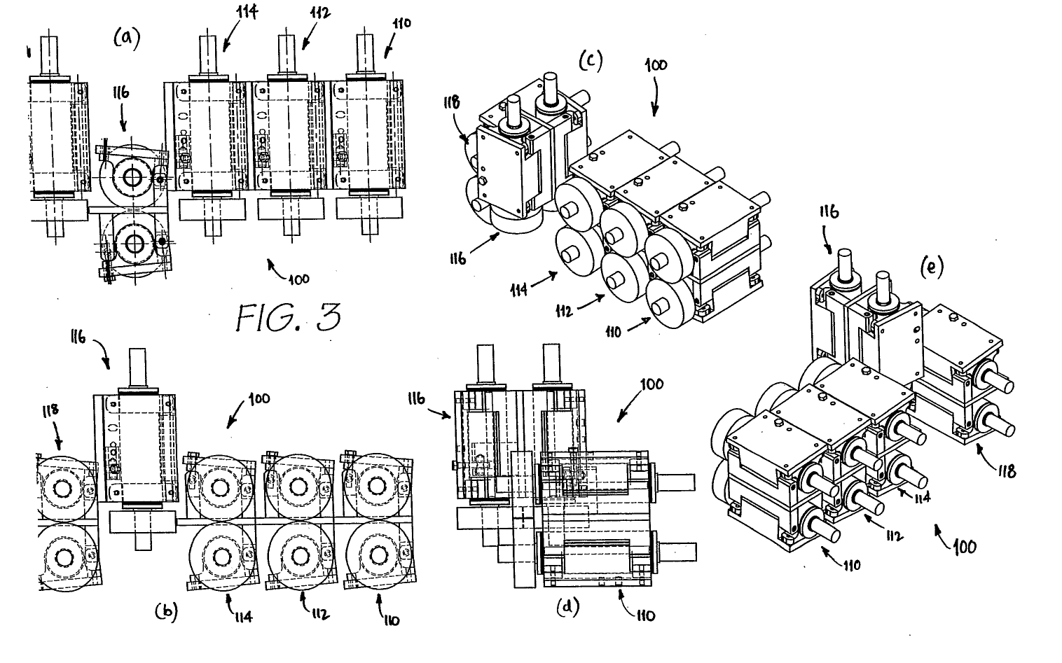

FIG. 1(g) shows a section 80 after the section 70 has been subjected to a fourth bending pass, which is performed to close the two ends 36 such that a close facing abutment at 82 starts to occur at a central location (top centre), and a hole 84 forms in the section. In this pass the hollow bar is first closed. As described below with reference to FIG. 3, this can occur in a roll pair (116) wherein the roll axes are vertical. This pass is operated such that, as the mating surfaces come into contact, lateral movement is controlled so as to keep the ends 36 together. However, it has been discovered that closure of the mating faces at this stage is not critical.

Also, in the fourth bending pass the curved portions 37 engage. Because of their curved profile it is surmised that the surfaces may roll over each other to facilitate subsequent close-facing abutment and, at the same time, to allow for further bending throughout the section. This rolling action, together with the oblique orientation of the bevelled surfaces, may help to prevent inward collapse of the now abutting section ends. Also in the fourth pass some minor form work again takes place on the section to further assist with closure of the section ends.

FIG. 1(h) shows a section 90 after the section 80 has been subjected to a fifth and final bending pass, which is performed to flatten the top and bottom sides of the section 80, whilst retaining a hole 92 centrally in the section. In this pass the section 90 is prepared for a final work roll pass, with the flattening sizing the top and bottom sides. In the flattening performed by this pass the mating faces are further closed to further define the close-facing abutment. In this regard the bevelled faces 38 now abut and can be forced further together at 94.

When the section enters the final roll pass in the sequence of roll passes, the initial roll contact is generally perpendicular to a vertical line through the join 94, to further close the hollow bar at region 16. Section 90 is thus worked on in the horizontal plane. In this final pass, the rolling force causes the section 90 to fill the pass so that the ribs 12 are formed. Also, in the final pass the section elongates by around 15%.

In the rolling process described, during the various bending stages the wall thickness is maintained to be essentially uniform and there is no clearly defined or distinct hinge at any point or at any time. Rather, it can be seen that bending occurs at multiple points around the bar as it forms. Thus, the rolling and bending can be performed without the formation of or requirement for a definite (or distinct) hinge.

It should also be appreciated that FIGS. 1(a) to (h) indicate just one embodiment in a rolling process. Both the number of steps required and the final shapes reached can vary, depending on the type of bar to be produced and its end use. For example, the final profile shape need not be round; it could be elliptical, rectangular or square-like, oval etc.

FIG. 1(i) shows a finished hollow bar 10 after the section 90 has been subjected to the final forming pass. The ribs 12 are now formed on the outside of the bar 10. The bore 14 is now defined in the bar 10 and the close-facing abutment at region 16 has been defined, the region extending generally perpendicularly to the ribs 12 and in an axial direction along the length of the bar.

The bore need not be centrally located as depicted. In unworn passes the hole may in fact be located, in end profile, towards a bottom of the bar, opposite the region 16. However, as pass wear occurs the bore may progressively move up through the centre of the bar towards the region, until such time as the tolerance has been exceeded and it would be necessary to exchange the roll passes, particularly in passes producing sections 30 and 40.

The close-facing abutment at region 16 can be fluid-tight. However, for many applications, the joint need not be fluid tight and, if not, may still be fit for purpose. If fluid under pressure is pumped through a bar having a non fluid-tight joint this may result in a fine spray exiting the bar via the joint, which may still be acceptable in the given application. In either case, hollow bar samples can be pressure tested at the mill to confirm a specification and thus application.

In an alternative configuration of the process, the bending operation can be performed such that the two ends 36 are not urged hard together in the passes of FIGS. 1(g) and (h). In this case, it has been observed that a section can be rolled with a gap between the ends of up to about 2-3 mm.

The wall thickness can be varied as desired in the roll forming passes (b) and (c). For example, the process is able to produce bar with a D/t ratio of as low as at least 3 (ie. an extremely heavy wall). For instance a bar section of 33.7×4.0 mm would have a D/t ratio of 8.5 and be described as “chunky”. A section of 21.3×4.5 mm would have a D/t ratio of 4.7 and be described as “very heavy wall”. A hollow bar section of this process with nominal 27×8.5 mm would have an equivalent D/t of 3.2.

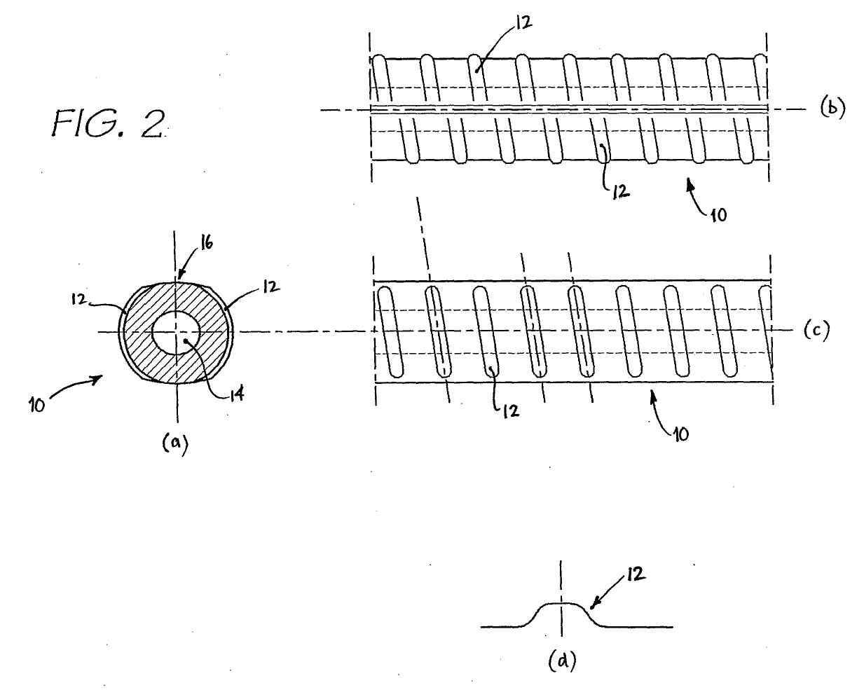

FIG. 2 shows the resultant hollow bar 10 from the process of FIG. 1. It will be seen that the thread resulting from ribs 12 does not extend continuously around the bar 10 but, for ease of thread formation during hot rolling, is located as discrete thread portions on the left and right sides of the bar (FIG. 2(a)).

In addition, as shown in FIG. 2(b), and again for ease of thread formation during hot rolling, the thread on one side of the bar is offset from the thread on the other side of the bar. This offset formation does not prevent the screw-thread mounting of a cutting tip etc to the bar, nor does it prevent the screw-thread mounting of the bar in a drilling apparatus etc.

FIG. 3 shows a compact hot rolling mill unit 100 in which the bending operations (sequence steps (d) to (h) of FIG. 1) to produce the hollow bar of FIG. 2 take place. The unit 100 replaces what would otherwise be a series of bending passes in a standard mill. Thus, it simplifies both the manufacture and formation of the hollow bar 10, and improves process economics.

In FIGS. 3(a) to 3(c) the feed direction is from right to left (left to right in FIG. 3(e)).

In operation, the formed (or worked) section 40 enters a first horizontal roll 110, being the first of a group of three horizontal rolls 110, 112 and 114. The first horizontal roll 110 is configured to bend the section 40 to produce the section 50 (step 1(d)). In the second horizontal roll 112 the section 50 is bent to produce the section 60 (step 1(e)). In the third horizontal roll 114 the section 60 is bent to produce the section 70 (step 1(f)).

The section 70 is then passed to vertical rolls 116. This roll pair closes the section into its elliptical profile and starts to form the close facing abutment at 82 (see section 80 as shown in FIG. 1(g)).

The last roll pair 118 takes the section 80, flattens it to produce section 90 and thus further forms the a close-facing abutment at 94 (see section 90 as shown in FIG. 1(h)).

The section 90 is passed from the unit 100 to a final work roll where the hollow bar 10 is produced.

Whilst a five pass bending operation has been described, it may be possible to operate this part of the process with less or more than five passes. For example, the number of initial bending roll pairs can be reduced from three to two, and more bending can be performed in those two.

The process as described finds particular though not exclusive application in the production of a thick-walled hollow bar for use as feedstock for a rock bolt or drill rod. However, the process can be used to produce thick-walled hollow bar for any end use. In this regard, the formation of a thread (ribs) at the final forming pass can be omitted.

Because the process does not produce or form a hinge, potential bar weakness under torsional loads is mitigated. A typical torque required for drilling operations is 100 kNm, with maximum torques applied being as high as 300 kNm. Were there to be a crack or material defect at a hinge, this can cause the bar to fail, to leak fluid and thus render it ineffective.

The feed bar is typically of a steel suitable for hot roll forming, such as a mild steel. However, the steel may comprise stainless steel or other steel alloys that can be hot roll formed. For example, high strength steel can be hot rolled that comprises small amounts of nickel, chromium, vanadium, molybdenum or other alloying additives. Indeed other metals (such as lead, aluminium etc) may be roll formed using the process.

The bore through the hollow bar can be formed to have any desired shape. In addition, whilst the hollow bar shown in the drawings has a generally circular cross-section, the bar may have a variety of cross-sectional shapes including hexagonal, octagonal, square, rectangular, elliptical etc. Again, where the bar final profile has no ribs, it may still have a round, hexagonal, square, octagonal etc -shaped profile.

The process results in closely abutting faces along the length of the hollow bar, and this may enable the bar to receive fluids pumped into and/or through the bore. Whilst the process as described typically results in closely abutting faces, the process may be operated such that the faces are only brought into proximity of each other. In either case, a conventional welding process, or roll forge welding or hot forging, or laser welding or brazing can be employed to provide a final join.

Whilst the process and apparatus for hot rolling a hollow bar has been described with reference to particular embodiments, it should be appreciated that the process can be embodied in many other forms.

1. A process for forming a relatively thick-walled hollow bar by hot rolling an elongate member, the process comprising the steps:
(i) in at least one pass, rolling the elongate member so as to generally define at least two longitudinally extending portions of the hollow bar;
(ii) in at least one pass, bending the resultant rolled member from (i) so as to bring outer edges of the elongate member into proximity with each other;
wherein after step (i) the resultant portions are interconnected by a longitudinal region of bar material that is formed so as not to act as a hinge during bending step (ii).

2. A process as claimed in claim 1, wherein the longitudinal region of bar material is formed to have substantially the same thickness as the portions.

3. A process as claimed in claim 1, wherein in step (ii) the elongate member outer edges are brought together into close-facing abutment.

4. A process as claimed in claim 3, wherein in step (i) ends of the elongate member outer edges each have a mating surface formed thereon to assist in the obtaining of a close-facing abutment.

5. A process as claimed in claim 4, wherein, in end profile, each mating surface comprises a curved portion and a bevelled portion whereby, when the outer edges are brought together, the curved portions initially engage and roll over each other until the bevelled portions come into direct facing engagement, thus enabling close-facing abutment.

6. A process as claimed in claim 1, further comprising a final roll pass after the bending step (ii) in which the final profile of the hollow bar is formed.

7. A process as claimed in claim 6, wherein, in the final roll pass, a plurality of ribs are formed at the external surface of the hollow bar.

8. A process as claimed in claim 7, wherein the plurality of ribs are formed so as to define a thread on the external surface of the hollow bar.

9. A process as claimed in claim 1, wherein in step (i) the elongate member is rolled in a first pass to define two longitudinally extending portions, each having a U-shape in end profile, with the longitudinal region of bar material interconnecting the two longitudinally extending portions.

10. A process as claimed in claim 9, wherein in step (i) the member resulting from the first pass is rolled in a second pass to further define the U-shaped profile of each of the two longitudinally extending portions, and to define an inverted U-shaped profile in the longitudinal region of bar material that interconnects the two longitudinally extending portions.

11. A process as claimed in claim 10, wherein in step (ii) the member resulting from the second pass is subjected to a five pass bending operation in which opposing edge regions of the member are progressively brought together, thereby bringing end surfaces of the outer edges of the member into abutment.

12. A process as claimed in claim 11, wherein in step (ii) the bending operation takes place in a hot rolling mill unit comprising five adjacent roll pairs, with each roll pair performing a next successive pass in the bending operation, without the formation of a hinge in the member.

13. A process as claimed in claim 12, wherein the hot rolling mill unit operates at a speed which is consistent with the speed of operation of the roll forming step (i).

14. A process as claimed in claim 1, wherein the elongate member comprises steel.

15. A process as claimed in claim 1 that forms part of a hot rolling process in a steel mill.

16. A process as claimed in claim 1, wherein the hollow bar provides feedstock for a rock bolt or a drill rod.

17. A process for forming a relatively thick-walled hollow bar by hot rolling an elongate member, wherein the rolling takes place in a manner whereby no hinge is produced during formation of the hollow bar.

18. A process as claimed in claim 17 that comprises steps (i) and (ii) of claim 1.

19. Apparatus for bending a hot rolled elongate member so as to form a hollow bar, the apparatus comprising a plurality of adjacent roll pairs which are oriented so as to cause outer edges of the elongate member to progressively be brought into proximity with each other, whereby a hollow bar is formed.

20. Apparatus as claimed in claim 19 comprising three adjacent horizontal roll pairs into which the elongate member is progressively fed to progressively bend distal edges of the elongate member towards each other, and a next adjacent vertical roll pair to bend the distal edges such that the outer edges are caused to abut and form a hollow bar.

21. Apparatus as claimed in claim 20 comprising a final horizontal roll pair into which the hollow bar from the vertical roll pair is fed to bring the outer edges together and into a close-facing abutment.

22. (canceled)

23. (canceled)

24. (canceled)
